(19) United States
(12) Patent Application Publication
(10) Pub. No.: US 2010/0153947 A1
(43) Pub. Date: Jun. 17, 2010

(54) INFORMATION SYSTEM, METHOD OF CONTROLLING INFORMATION, AND CONTROL APPARATUS

(75) Inventor: Toshiyuki Haruma, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/388,055

(22) Filed: Feb. 18, 2009

(30) Foreign Application Priority Data
Dec. 11, 2008 (JP) 2008-316090

(51) Int. Cl. G06F 9/455

(52) U.S. Cl. 718/1

(57) ABSTRACT

Provided is an information system including a server apparatus having a virtualization control unit which implements a virtual machine, and a storage apparatus having a virtual logical volume management unit which provides a virtual logical volume (VLU) configured by using a real logical volume (RLU). In the system, the VLU is allocated to each of the virtual machines implemented in the same server apparatus, the RLUs configuring the VLU for each virtual machine differ depending on the virtual machine, an identifier of the virtual machine is added to an I/O request of the virtual machine, the I/O request with the identifier is transmitted to the storage apparatus, and the RLU as a target in the I/O request is identified based on the identifier by the storage apparatus.

### CROSS-REFERENCE TO RELATED APPLICATIONS

The present application claims a priority from Japanese Patent Application No. 2008-316090 filed on Dec. 11, 2008, the content of which herein incorporated by reference.

### BACKGROUND OF THE INVENTION

1. Field of the Invention

The present invention relates to an information system, a method of controlling information, and a control apparatus, and particularly relates to a technique for enabling allocation of a hardware resource depending on a virtual machine and for reducing the load on a user at the time of a configuration change of the virtual machine.

2. Related Art

In recent years, in information system operation sites, a so-called virtualization technique has increasingly been introduced for the purpose of efficiently utilizing hardware resources, improving portability, facilitating migration, or the like. In the virtualization technique, virtual machines are configured by which an application and an operating system can be executed independently on the same information apparatus.

Generally, in the information system using the virtualization technique, characteristics of data treated by the virtual machines and reliability required for management of the data are not always uniform, and normally vary with each virtual machine. Therefore, in operations of the information system using the virtual machines, it is required to appropriately allocate the hardware resource to each of the virtual machines, according to the priority of the data treated by the virtual machines or the required reliabilities, e.g., a high-performance hardware resource is allocated to data requiring a high access performance, and a high-reliability hardware resource is allocated to data of high priority.

For example, Japanese Patent Application Laid-open Publication No. 2007-140919 describes the following processing. Firstly, operation information is collected for each volume. Secondly, a data requirement level and a volume acceptance level are calculated based on the collected operation information. Specifically, the data requirement level is a performance level required for a volume which stores data to be migrated, and the volume acceptance level is a performance level of each volume configured in a storage apparatus. Thirdly, based on the calculated data requirement level and volume acceptance level, the data to be migrated is moved to another volume having a volume acceptance level which satisfies the data requirement level required for the volume to store the migration target data.

When the hardware resource is allocated to the virtual machine, there occurs partitioning work of the hardware resource. Therefore, especially in an information system which deals with a number of virtual machines, the user is forced to go through extremely troublesome work in a configuration change such as an addition, deletion, migration, or the like of the virtual machine.

### SUMMARY OF THE INVENTION

The present invention has been made in view of such a problem, and an object thereof is to provide an information system, a method of controlling information, and a control apparatus which enables a different hardware resource to be allocated to each virtual machine and which can reduce the load on the user at the time of a configuration change of the virtual machine.

One aspect of the present invention for achieving the object provides an information system comprising: a server apparatus; and a storage apparatus coupled to the server apparatus. The server apparatus includes a virtualization control unit which implements a virtual machine. The storage apparatus includes a virtual logical volume management unit which provides the server apparatus with a virtual logical volume configured by using a real logical volume. The storage apparatus allocates the virtual logical volume to each of the virtual machines implemented in the same server apparatus and configures the real logical volume configuring the virtual logical volume so that the real logical volumes configuring the virtual logical volumes allocated to the virtual machines are different from each other depending on the virtual machine. The server apparatus transmits to the storage apparatus an I/O request with an identifier of the virtual machine added when the I/O request is made by the virtual machine. The storage apparatus identifies the real logical volume of an access target in the I/O request on the basis of the identifier of the virtual machine, which is added to the I/O request.

As described above, in the present invention, the virtual logical volume is allocated to each of the virtual machines implemented in the same server apparatus, while the real logical volume configuring the virtual logical volume is configured so that the real logical volume configuring the virtual logical volume allocated to each of the virtual machines differs depending on the virtual machine. Also, when an I/O request is made by the virtual machine, the server apparatus transmits to the storage apparatus an I/O request with an identifier of the virtual machine added, and the storage apparatus identities the real logical volume as an access target in the I/O request on the basis of the virtual machine identifier added to the I/O request.

With these configurations, partitioning work of a hardware resource does not occur even when the configuration change of the virtual machine is made, and the load on the user at the time of the configuration change can be reduced.

Another aspect of the present invention provides the information system, further comprising a control apparatus coupled to the server apparatus and the storage apparatus. The control apparatus stores a server apparatus management table storing a correspondence between the server apparatus and the virtual logical volume allocated to the server apparatus; a virtual machine/server apparatus management table storing a correspondence between the virtual machine and the server apparatus; a virtual logical volume/real logical volume management table storing a correspondence between the virtual logical volume and the real logical volume; and a real logical volume/virtual machine management table storing a correspondence between the real logical volume and the virtual machine. The server apparatus stores a virtual machine management table storing an identifier of a virtual machine implemented in the server apparatus itself. The storage apparatus stores a virtual logical volume/real logical volume/virtual machine management table storing a correspondence among the virtual logical volume, the virtual machine, and the real logical volume. When a configuration change is made on the virtual machine implemented in the server apparatus, at least one of the control apparatus, the server apparatus, and the storage apparatus updates contents of the server apparatus management table, the virtual machine/server apparatus management table, the virtual logical volume/real logical volume management table, the real logical volume/virtual machine management table, the virtual machine management table, and the virtual logical volume/real logical volume/virtual machine management table, to the contents in a status after the configuration change.

As described above, the virtual logical volume is allocated to each of the virtual machines implemented in the same server apparatus, while the real logical volume configuring the virtual logical volume is configured so that the real logical volume configuring the virtual logical volume allocated to each of the virtual machines differs depending on the virtual machine. Furthermore, when an I/O request is made by the virtual machine, the server apparatus transmits to the storage apparatus an I/O request with an identifier of the virtual machine added, and the storage apparatus identifies the real logical volume as an access target in the I/O request on the basis of the identifier of the virtual machine added to the I/O request. The above configuration can be easily implemented, when the control apparatus, server apparatus and storage apparatus appropriately sets contents of the server apparatus management table, virtual machine/server apparatus management table, virtual logical volume/real logical volume management table, real logical volume/virtual machine management table, virtual machine management table and virtual logical volume/real logical volume/virtual machine management table.

Note that the change of configuration indicated above is, for example, any one of an addition of a virtual machine to the server apparatus, a deletion of the virtual machine from the server apparatus, and a migration of the virtual machine from a first server apparatus to a second server apparatus.

Another aspect of the present invention provides the information system. The configuration change is the addition of the virtual machine to the server apparatus. The control apparatus transmits, to the storage apparatus, an allocation request for allocating the virtual logical volume to the server apparatus when the virtual logical volume is not allocated to the server apparatus to which the virtual machine is added. The storage apparatus allocates the virtual logical volume and an I/O path from the virtual machine to the virtual logical volume, to the server apparatus in response to the allocation request.

As described above, when a virtual machine is added to the server apparatus, the control apparatus transmits to the storage apparatus the allocation request for allocation of the virtual logical volume to the server apparatus, and the storage apparatus allocates the virtual logical volume and the I/O path from the virtual machine to the virtual logical volume, to the server apparatus in response to the allocation request. Therefore, the necessary configuration change is performed automatically even when the virtual machine is added to the server apparatus, and the contents of the tables are automatically updated to appropriate contents.

Another aspect of the present invention provides the information system. The configuration change is the deletion of the virtual machine from the server apparatus or the migration of the virtual machine from the first server apparatus to the second server apparatus. The control apparatus transmits, to the storage apparatus, an allocation release request of an I/O path from the virtual machine to the virtual logical volume when the virtual machine no longer exists in the server apparatus due to the deletion of the virtual machine. The storage apparatus releases the allocation of the I/O path in response to the allocation release request.

As described above, in the case where the deletion of the virtual machine from the server apparatus or the migration of the virtual machine from the first server apparatus to the second server apparatus is performed and the deletion of the virtual machine results in absence of the virtual machine in the server apparatus, the control apparatus transmits to the storage apparatus the allocation release request for release of the I/O path from the virtual machine to the virtual logical volume, and the storage apparatus accordingly releases the allocation of the I/O path. As described above, when the virtual machine no longer exists in the server apparatus due to the deletion or migration by the server apparatus and the resultant absence of the virtual machine in the server apparatus, the allocation of the I/O path is automatically released. Accordingly, the contents of the tables are automatically updated to appropriate contents.

Other problems and solutions thereof disclosed in the present application will become apparent by reading the detailed description of the invention with reference to the drawings.

According to the present invention, a different hardware resource can be allocated to each virtual machine, and the load on the user at the time of the configuration change of the virtual machine can be reduced.

### BRIEF DESCRIPTION OF THE DRAWINGS

FIG. 1A is a view showing a schematic configuration of an information system 1;

FIG. 1B is a view showing an example of a hardware configuration of a computer 100 (information apparatus) which can be utilized as a control apparatus 10, a server apparatus 20, and a client apparatus 60;

FIG. 1C is a view showing an example of a hardware configuration of a storage apparatus 30;

FIG. 1D is a view showing an example of a hardware configuration of a switch shown as an example of a network apparatus used for configuring a storage network 4;

FIG. 2 is a view showing main functions of the control apparatus 10, the server apparatus 20, and the storage apparatus 30, and main tables (a table may be abbreviated as “TBL”) managed by the control apparatus 10, the server apparatus 20, and the storage apparatus 30;

FIG. 3A is a view showing an example of a server apparatus management table 13;

FIG. 3B is a view showing an example of a virtual machine/server apparatus management table 14;

FIG. 3C is a view showing an example of a VLU/RLU management table 15;

FIG. 3D is a view showing an example of an RLU/virtual machine management table 16;

FIG. 3E is a view showing an example of a virtual machine management table 24 (server #1);

FIG. 3F is a view showing an example of a virtual machine management table 24 (server #2);

FIG. 3G is a view showing an example of a VLU/RLU/virtual machine management table 354;

FIG. 4A is a view showing a status before addition of a virtual machine 21 (VM #3) to the server apparatus 20 (server #2);

FIG. 4B is a view showing a status after the addition of the virtual machine 21 (VM #3) to the server apparatus 20 (server #2);

FIG. 5A is a view showing a change of the server apparatus management table 13 at the time of configuration change from the status of FIG. 4A to the status of FIG. 4B;

FIG. 5B is a view showing a change of the virtual machine/server apparatus management table 14 at the time of the configuration change from the status of FIG. 4A to the status of FIG. 4B;

FIG. 5C is a view showing a change of the VLU/RLU management table 15 at the time of the configuration change from the status of FIG. 4A to the status of FIG. 4B;

FIG. 5D is a view showing a change of the RLU/virtual machine management table 16 at the time of the configuration change from the status of FIG. 4A to the status of FIG. 4B;

FIG. 5E is a view showing a change of the virtual machine management table 24 (server #1) at the time of the configuration change from the status of FIG. 4A to the status of FIG. 4B;

FIG. 5F is a view showing a change of the virtual machine management table 24 (server #2) at the time of the configuration change from the status of FIG. 4A to the status of FIG. 4B;

FIG. 5G is a view showing a change of the VLU/RLU/virtual machine management table 354 at the time of the configuration change from the status of FIG. 4A to the status of FIG. 4B;

FIG. 6 is a flowchart illustrating virtual machine addition processing S600;

FIG. 7A is a view showing a status before deletion of the virtual machine 21 (VM #3) from the server apparatus 20 (server #2);

FIG. 7B is a view showing a status after the deletion of the virtual machine 21 (VM #3) from the server apparatus 20 (server #2);

FIG. 8A is a view showing a change of the server apparatus management table 13 at the time of configuration change from the status of FIG. 7A to the status of FIG. 7B;

FIG. 8B is a view showing a change of the virtual machine/server apparatus management table 14 at the time of the configuration change from the status of FIG. 7A to the status of FIG. 7B;

FIG. 8C is a view showing a change of the VLU/RLU management table 15 at the time of the configuration change from the status of FIG. 7A to the status of FIG. 7B;

FIG. 8D is a view showing a change of the RLU/virtual machine management table 16 at the time of the configuration change from the status of FIG. 7A to the status of FIG. 7B;

FIG. 8E is a view showing a change of the virtual machine management table 24 (server #1) at the time of the configuration change from the status of FIG. 7A to the status of FIG. 7B;

FIG. 8F is a view showing a change of the virtual machine management table 24 (server #2) at the time of the configuration change from the status of FIG. 7A to the status of FIG. 7B;

FIG. 8G is a view showing a change of the VLU/RLU/virtual machine management table 354 at the time of the configuration change from the status of FIG. 7A to the status of FIG. 7B;

FIG. 9 is a flowchart illustrating virtual machine deletion processing S900;

FIG. 10A is a view showing a status before migration of the virtual machine 21 (VM #2) in the server apparatus 20 (server #1) to the server apparatus 20 (server #2);

FIG. 10B is a view showing a status after the migration of the virtual machine 21 (VM #2) which was in the server apparatus 20 (server #1) to the server apparatus 20 (server #2);

FIG. 11A is a view showing a change of the server apparatus management table 13 at the time of configuration change from the status of FIG. 10A to the status of FIG. 10B;

FIG. 11B is a view showing a change of the virtual machine/server apparatus management table 14 at the time of the configuration change from the status of FIG. 10A to the status of FIG. 10B;

FIG. 11C is a view showing a change of the VLU/RLU management table 15 at the time of the configuration change from the status of FIG. 10A to the status of FIG. 10B;

FIG. 11D is a view showing a change of the RLU/virtual machine management table 16 at the time of the configuration change from the status of FIG. 10A to the status of FIG. 10B;

FIG. 11E is a view showing a change of the virtual machine management table 24 (server #1) at the time of the configuration change from the status of FIG. 10A to the status of FIG. 10B;

FIG. 11F is a view showing a change of the virtual machine management table 24 (server #2) at the time of the configuration change from the status of FIG. 10A to the status of FIG. 10B;

FIG. 11G is a view showing a change of the VLU/RLU/virtual machine management table 354 at the time of the configuration change from the status of FIG. 10A to the status of FIG. 10B;

FIG. 12 is a flowchart illustrating virtual machine migration processing S1200;

FIG. 13 is a flowchart illustrating I/O request occurrence processing S1300; and

FIG. 14 is a diagram illustrating a FC-PH data frame 1400.

### DETAILED DESCRIPTION OF THE INVENTION

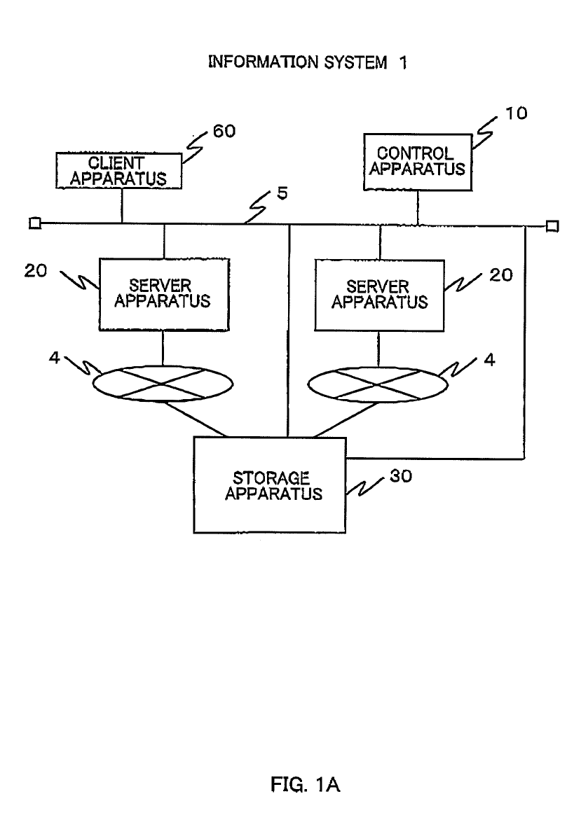

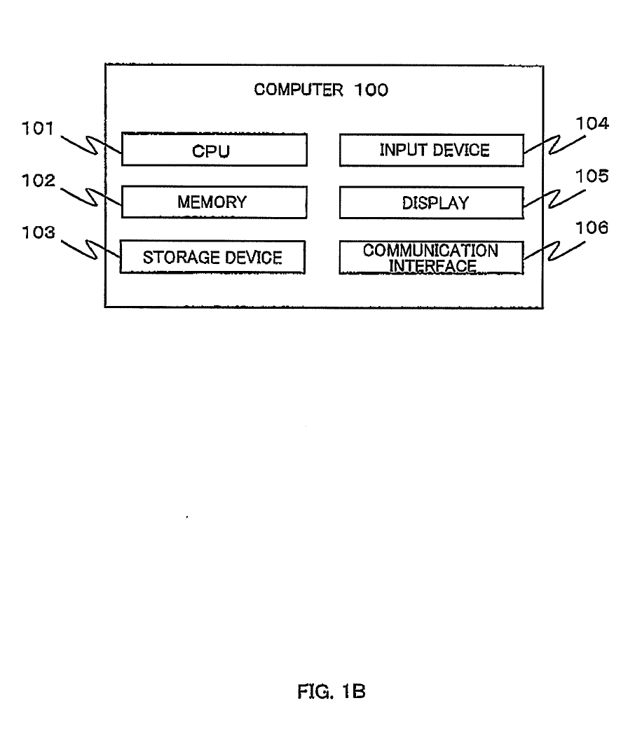

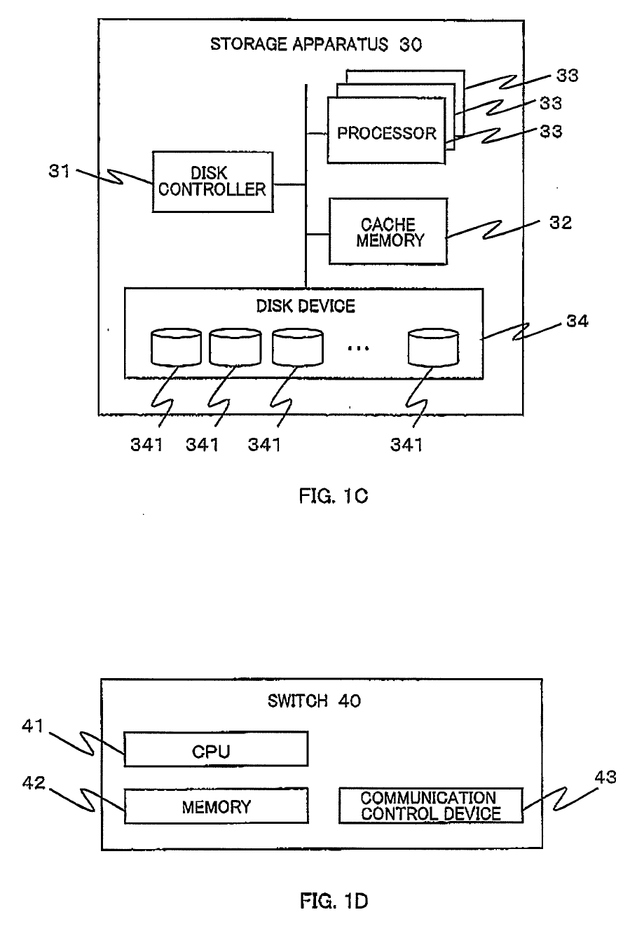

Hereinafter, an embodiment will be described in detail with reference to the drawings. FIG. 1A shows a schematic configuration of an information system 1 to be described below. As shown in FIG. 1, the information system 1 includes a control apparatus 10, one or more server apparatuses 20, one or more storage apparatuses 30, a storage network 4 which communicatively couples the server apparatus 20 and the storage apparatus 30, and a communication network 5 which communicatively couples a client apparatus 60 and the server apparatus 20.

The control apparatus 10 is communicatively coupled to the server apparatus 20, a network apparatus such as a switch which implements the storage network 4, and the storage apparatus 30, via communication means. Note that the above communication means may be the communication network 5 or the storage network 4, or may be other communication means.

The server apparatus 20, the storage apparatus 30, and the storage network 4 configure a storage system in which data are inputted from and outputted to the storage apparatus 30 by the accessing of the server apparatus 20 to the storage apparatus 30 via the storage network 4. The control apparatus 10 performs configuration management or monitoring control of the storage system.

The server apparatus 20 is coupled to the storage apparatus 30 via the storage network 4. The server apparatus 20 issues an I/O request (data write request, data read request, or the like) to the storage apparatus 30 on the basis of a data access request received from the client apparatus 60, and provides various data services to the client apparatus 60.

The storage network 4 is, for example, a local area network (LAN), a storage area network (SAN), a wide area network (WAN), the Internet, a public communication network, a special purpose line, or the like. And, the communication network 5 is, for example, a LAN, a WAN, the Internet, a public communication network, a special purpose line, or the like.

The server apparatus 20, the network apparatus (which configures the storage network 4, e.g., a LAN switch (100 BASE-T or the like) or a SAN switch (fibre channel switch or the like)), and the storage apparatus 30 each include a communication port through which data in communication via the storage network 4 is inputted or outputted. The coupling relation among the communication ports is set by, for example, the control apparatus 10. Note that, in the descriptions below, the storage network 4 is the SAN configured by using the SAN switch, and the communication network 5 is the LAN configured by using the LAN switch. The communication in the storage network 4 is performed according to a fibre channel protocol, and the communication in the communication network 5 is performed using an Ethernet® and a TCP/IP.

FIG. 1B shows an example of a hardware configuration of a computer 100 (information apparatus) which can be utilized as the control apparatus 10, the server apparatus 20, and the client apparatus 60. As shown in FIG. 1B, the computer 100 includes a CPU 101, a memory 102 (a random access memory (RAM) or a read only memory (ROM)), a storage device 103 (e.g., a hard disk or a solid state drive (SSD)), an input device 104 (keyboard, mouse, or the like) which receives an operation input from the user, a display 105 (a liquid crystal monitor, a cathode-ray tube display, or the like), and a communication interface 106 (network interface card (NIC), host bus adapter (HBA), or the like) which communicates with another device.

FIG. 1C shows an example of a hardware configuration of the storage apparatus 30. As shown in FIG. 1C, the storage apparatus 30 includes a disk controller 31, a cache memory 32, processors 33, and a disk device 34.

The processor 33 communicates with the server apparatus 20 or the control apparatus 10 via a switch 40. The disk controller 31 includes a CPU and a memory. The disk controller 31 performs various processing for implementing the functions of the storage apparatus 30. The disk device 34 includes one or more hard disks 341 (physical disks). The hard disk 341 may be controlled by the disk controller 31 or the like by using redundant arrays of inexpensive (or independent) disks (RAID). The cache memory 32 stores, for example, data to be written to or read from the disk device 34. Note that a disk array device is an example of the storage apparatus 30 having the configuration described above.

FIG. 1D shows an example of a hardware configuration of the switch as an example of the networking apparatus used for configuring the storage network 4. As shown in FIG. 1D, the switch 40 includes a CPU 41, a memory 42, and a communication control device 43. The CPU 41 implements, for example, a management function of a correspondence relation of the communication port of the switch 40 and a network address, a filtering function, and a security function by executing a program stored in the memory 42. The memory 42 is, for example, a RAM, a ROM, or a nonvolatile memory (e.g., a flash memory). The memory 42 stores, for example, a program for implementing the functions described above; various tables for managing the correspondence of a source and a destination of a network address, port number, or the like; and setting information relating to the filtering function or the security function. The communication control device 43 is, for example, a switch controller, and performs a transfer control of a frame or packet inputted or outputted between the communication ports based on source information and destination information of the frame or packet inputted to or outputted from each communication port.

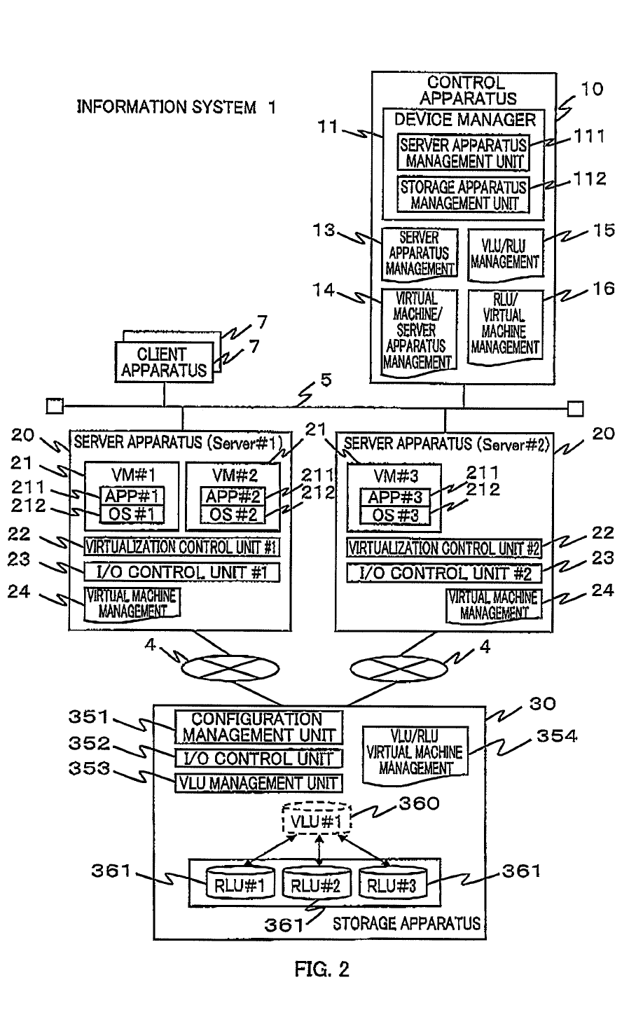

FIG. 2 shows main functions of the control apparatus 10, the server apparatus 20, and the storage apparatus 30 of the components of the information system 1, and main tables (a table may be abbreviated as “TBL”) managed respectively by the control apparatus 10, the server apparatus 20, and the storage apparatus 30. Note that the functions shown in FIG. 2 are implemented by a hardware included in each apparatus or when the CPU 101 or the processor 33 executes a program stored in the memory included in a memory 120 or the processor 33. The tables (data) are managed by a function of a database management system (DBMS).

As shown in FIG. 2, the server apparatus 20 has functions of a virtualization control unit 22 and an I/O control unit 23. The server apparatus 20 manages a virtual machine management table 24.

The virtualization control unit 22 implements virtual machines 21 (virtual computers) being a virtual hardware environment on the same hardware apparatus, and provides an installation environment of an operating system (hereinafter also called an “OS”) and application programs, and a set-up environment, execution environment, or the like thereof for each virtual machine 21 independently from one another. Methods for implementing the virtual machine 21 include, for example, full virtualization (hypervisor system) employed in VMware®, Kernel-based Virtual Machine (KVM)®, and the like, a paravirtualization employed in Xen® and the like, and an OS-level virtualization employed in Virtuozzo/OpenVZ®, and the like.

In FIG. 2, the server apparatus 20 (server #1) implements two virtual machines 21 (VM #1 and VM #2) by a virtualization control unit #1. The virtual machine 21 (VM #1) includes an operating system 212 (OS #1) and an application 211 (APP #1). The virtual machine 21 (VM #2) includes an operating system 212 (OS #2) and an application 211 (APP #2). And the server apparatus 20 (server #2) implements the virtual machine 21 (VM #3) by the virtualization control unit 22 (#2). The virtual machine 21 (VM #3) includes an operating system 212 (OS #3) and an application 211 (APP #3).

The I/O control unit 23 of the server apparatus 20 performs monitoring or control of data transmitted or received between the server apparatus 20 and the storage apparatus 30. The virtual machine management table 24 managed by the server apparatus 20 manages information (hereinafter called “virtual machine ID”) for identifying the virtual machine 21 implemented in the server apparatus 20.

As shown in FIG. 2, the storage apparatus 30 includes a configuration management unit 351, an I/O control unit 352, and a VLU management unit 353. The configuration management unit 351 manages and configures an I/O path between the server apparatus 20 and the storage apparatus 30 performed via the storage network 4. The I/O control unit 352 monitors and controls data transmitted or received between the server apparatus 20 and the storage apparatus 30. The VLU management unit 353 performs management (creation, erasure, access control, and the like) of a virtual logical volume (hereinafter called “virtual logical unit (VLU) 360”) which is a logical volume (logical unit (LU)) implemented virtually in the storage apparatus 30. The VLU 360 is configured by using a logical volume (hereinafter called “real logical unit (RLU) 361”) which is implemented by using a storage device (logical device (LDEV)). The storage device (LDEV) is, for example, a storage area of a RAID group.

Generation of the VLU 360 based on the RLU 361 is implemented by using, for example, a technique (hereinafter called “volume capacity virtualization technique”) of virtualizing the capacity of the volume. In this technique, an allocated amount of the RLU 361 for the VLU 360 is not fixed, but a storage area of the RLU 361 corresponding to a current usage amount of the VLU 360, for example, is allocated to the VLU 360 from a storage pool. A VLU/RLU/virtual machine management table 354 manages the correspondence among the VLU 360, the RLU 361, and the virtual machine 21.

As shown in FIG. 2, the control apparatus 10 includes a device manager 11. The device manager 11 includes a server apparatus management unit 111 and a storage apparatus management unit 112. The control apparatus 10 manages a server apparatus management table 13, a virtual machine/server apparatus management table 14, a VLU/RLU management table 15, and an RLU/virtual machine management table 16.

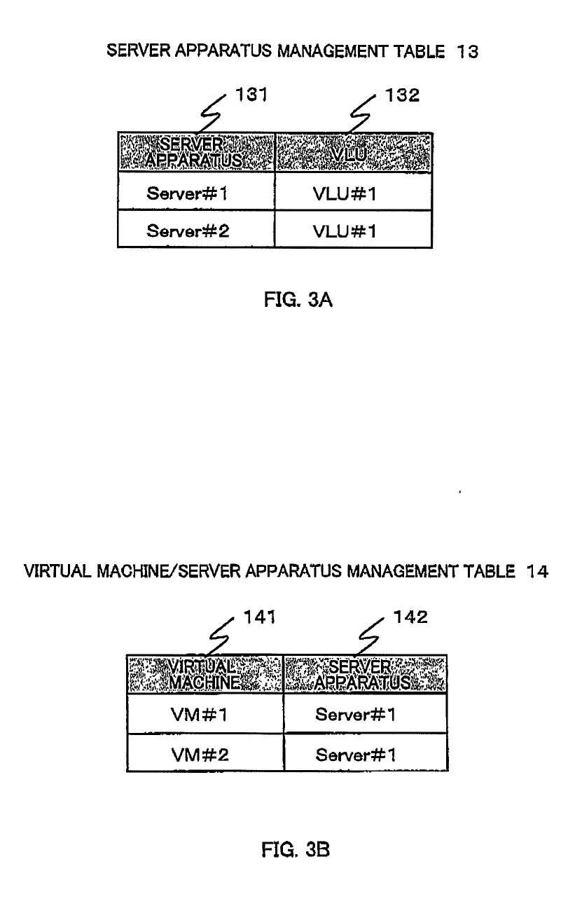

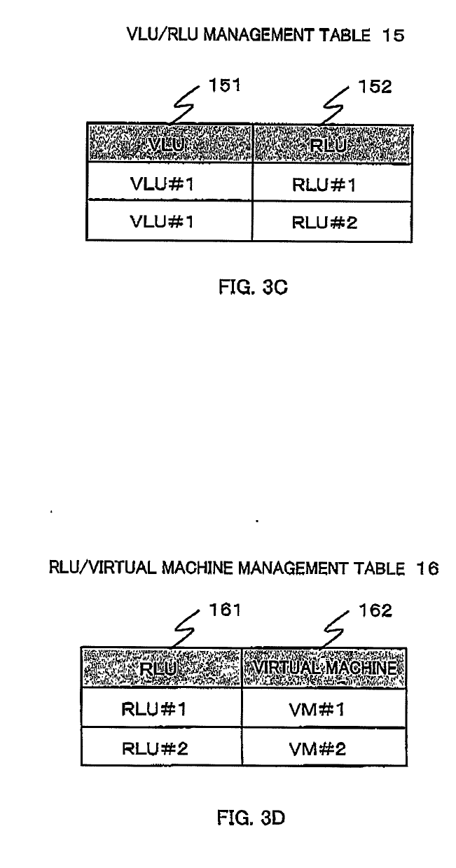

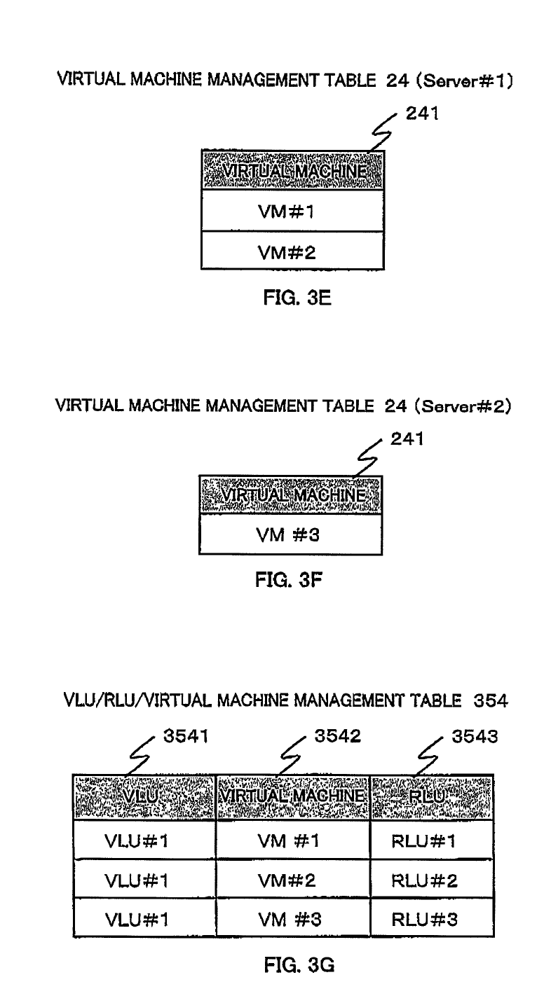

FIGS. 3A to 3G show examples of the various tables described above.

FIG. 3A is an example of the server apparatus management table 13. The server apparatus management table 13 manages the VLU 360 allocated to each server apparatus 20. As shown in FIG. 3A, the server apparatus management table 13 includes one or more records having items of a server apparatus 131 and a VLU 132.

FIG. 3B is an example of the virtual machine/server apparatus management table 14. The virtual machine/server apparatus management table 14 manages the correspondence between the virtual machine 21 and the server apparatus 20. As shown in FIG. 3B, the virtual machine/server apparatus management table 14 includes one or more records each having items of a virtual machine 141 and a server apparatus 142.

FIG. 3C is an example of the VLU/RLU management table 15. The VLU/RLU management table 15 manages the correspondence between the VLU 360 and the RLU 361. As shown in FIG. 3C, the VLU/RLU management table 15 includes one or more records each having items of a VLU 151 and an RLU 152.

FIG. 3D is an example of the RLU/virtual machine management table 16. The RLU/virtual machine management table 16 manages the correspondence between the RLU 361 and the virtual machine 21. As shown in FIG. 3D, the RLU/virtual machine management table 16 includes one or more records each having items of an RLU 161 and a virtual machine 162.

FIGS. 3E and 3F are examples of the virtual machine management table 24 managed by the server apparatus 20. FIG. 3E is an example of the virtual machine management table 24 managed by the server apparatus 20 (server #1) exemplified in FIG. 2. FIG. 3F is an example of the virtual machine management table 24 managed by the server apparatus 20 (server #2) exemplified in FIG. 2. The virtual machine management table 24 manages the virtual machine ID of the virtual machine 21 in the server apparatus 20. As shown in FIGS. 3E and 3F, the virtual machine management tables 24 each include one or more records each having an item (virtual machine 241) for which the virtual machine IDs are set.

FIG. 3G is an example of the VLU/RLU/virtual machine management table 354 managed by the storage apparatus 30. The VLU/RLU/virtual machine management table 354 manages the correspondence among the VLU 360, a virtual machine 3542, and the RLU 361. As shown in FIG. 3G, the VLU/RLU/virtual machine management table 354 includes one or more records each having items of a VLU 3541, a virtual machine 3542, and an RLU 3543. Note that, as shown in FIG. 3G, the same VLU 360 (although not necessarily the same) (VLU #1 in FIG. 3G) is allocated to the virtual machines 21 in the same server apparatus 20. Meanwhile, different RLUs 361 are allocated to the virtual machines 21, respectively.

Note that the numbers of records in the tables exemplified in FIGS. 3A to 3G are only examples, and no record may exist, for example, in an initial status.

### =Description of Processing=

Hereinafter, various processing performed in the information system 1 will be described. Note that the character “S” prefixed to a reference numeral denotes a process step, in the descriptions below.

<Processing when adding a Virtual Machine>

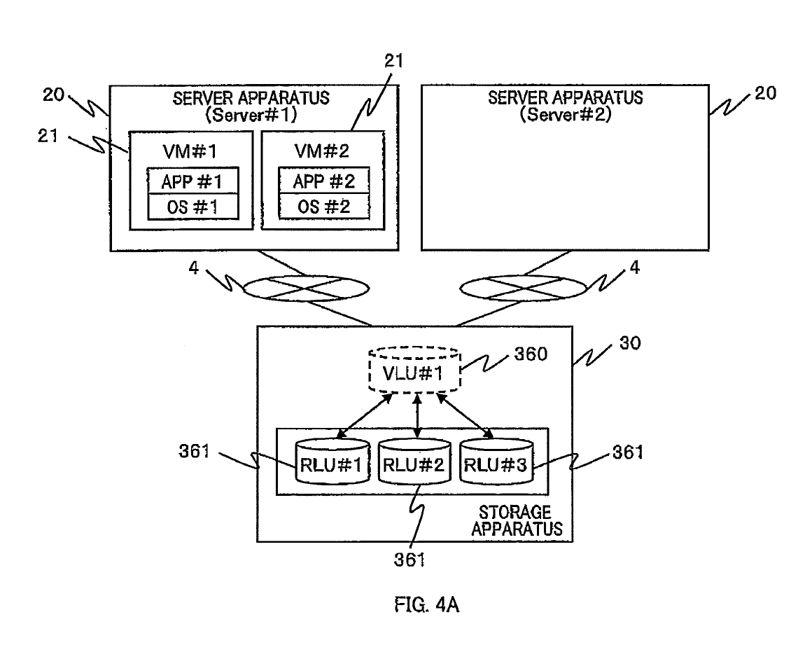

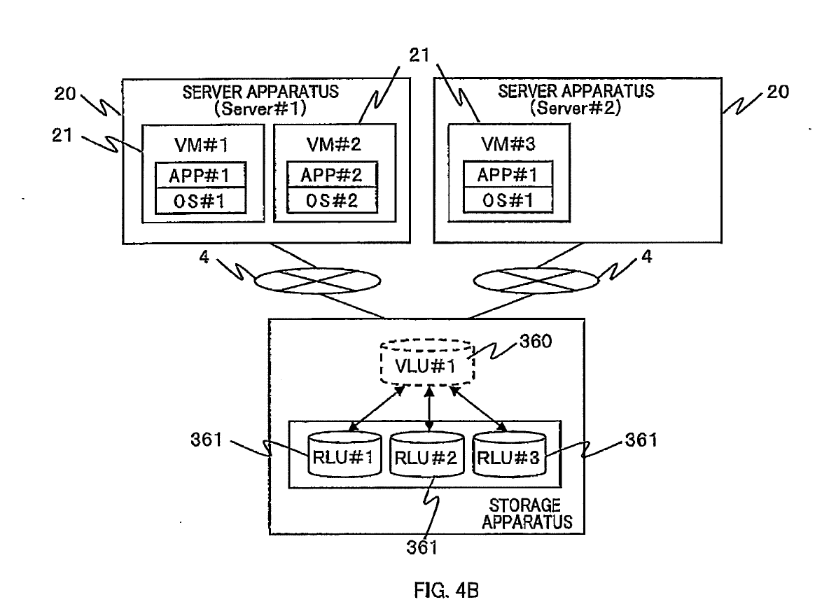

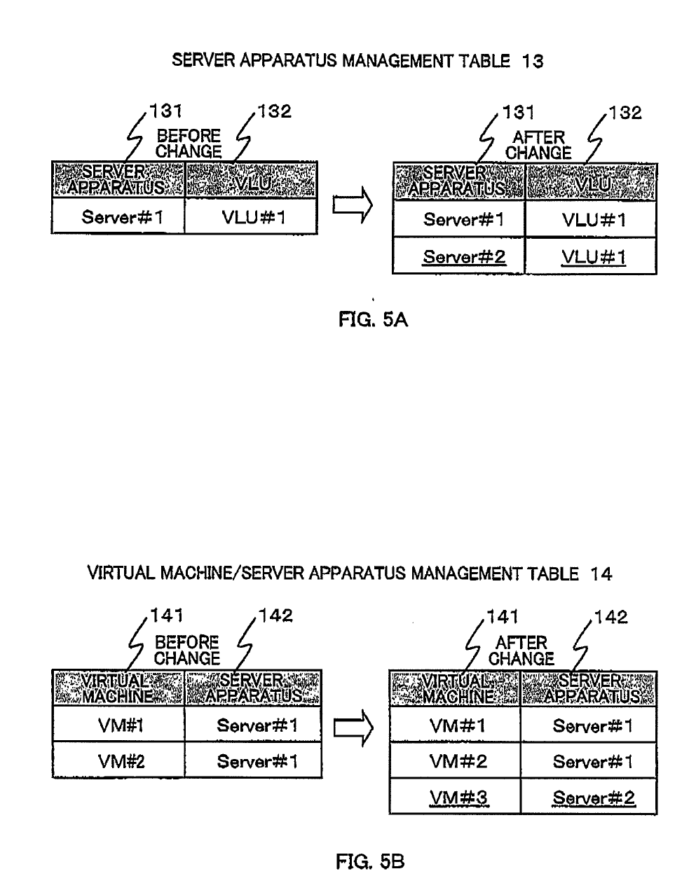

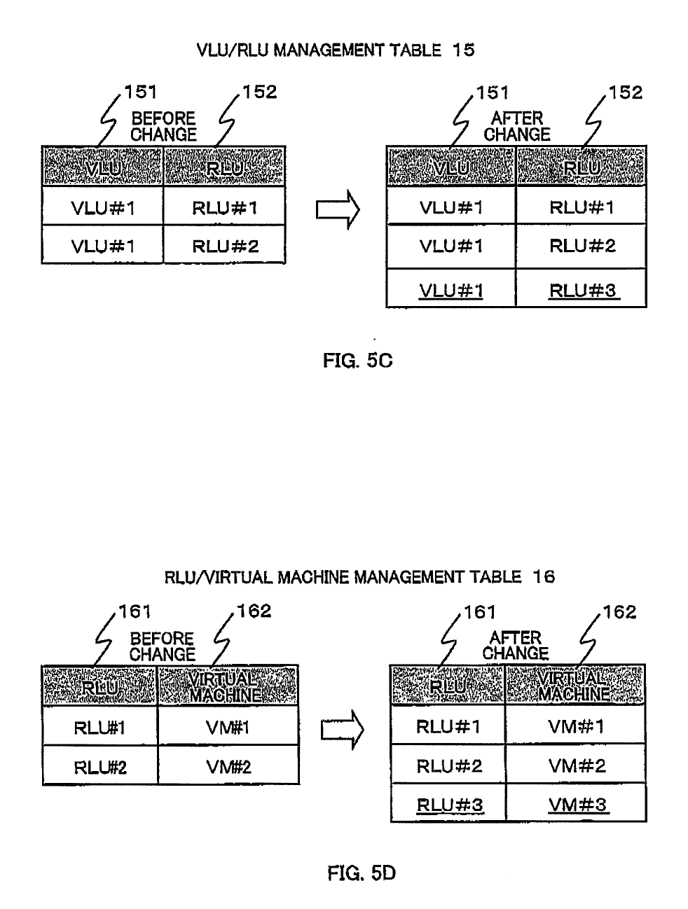

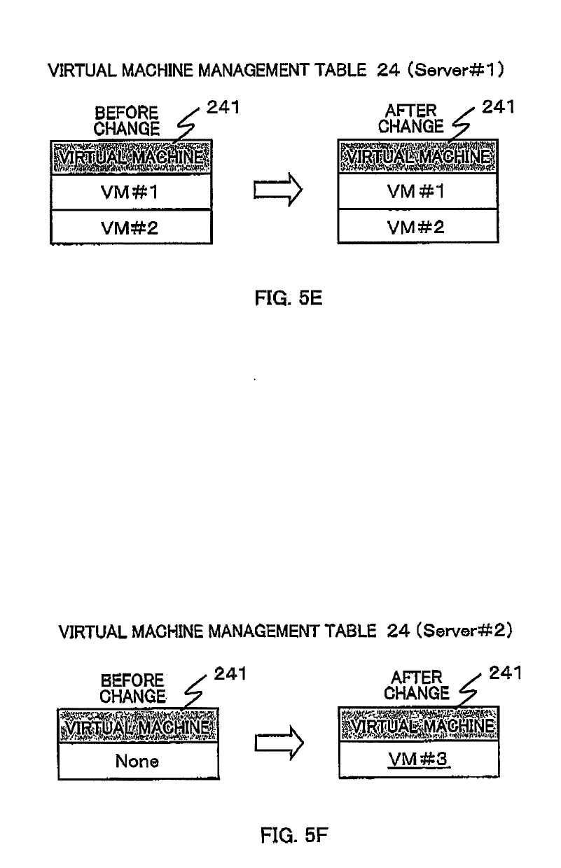

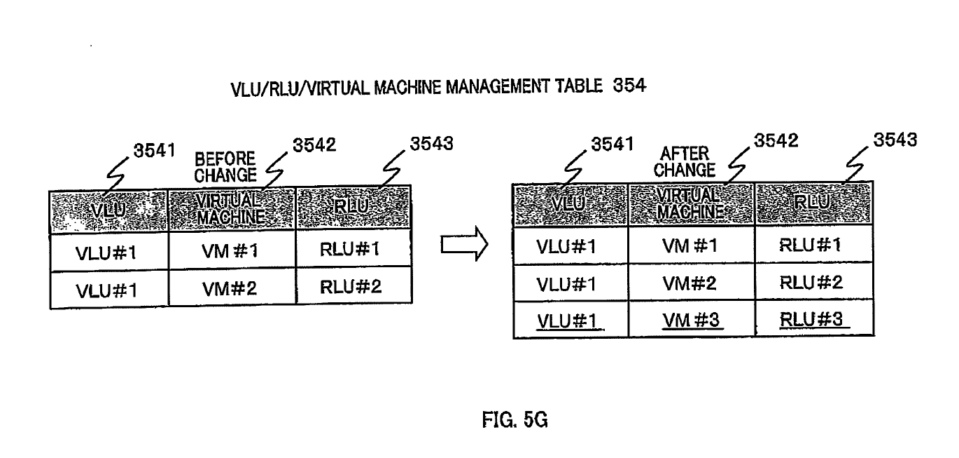

First, as a first case, processing performed when the virtual machine 21 is added to the server apparatus 20 will be described. FIGS. 4A and 4B are views illustrating the addition of the virtual machine 21 (VM #3) to the server apparatus 20 (server #2). FIG. 4A shows a status before the virtual machine 21 (VM #3) is added to the server apparatus 20 (server #2), and FIG. 4B shows a status after the virtual machine 21 (VM #3) has been added. FIGS. 5A to 5G are views illustrating changes in the respective tables at the time of configuration change from the status of FIG. 4A to the status of FIG. 4B.

As shown in FIG. 5A, when the virtual machine 21 (VM #3) is added to the server apparatus 20 (server #2), a record showing that the server apparatus 20 (server #2) and the VLU #1 correspond to each other is accordingly added to the server apparatus management table 13. As shown in FIG. 5B, a record showing that the virtual machine 21 (VM #3) and the server apparatus 20 (server #2) correspond to each other is added to the virtual machine/server apparatus management table 14. As shown in FIG. 5C, a record showing that the RLU 361 (RLU #3) is an element configuring the VLU 360 (VLU #1) is added to the VLU/RLU management table 15. Further, as shown in FIG. 5D, a record showing that the RLU 361 (RLU #3) is associated with the virtual machine 21 (VM #3) is added to the RLU/virtual machine management table 16.

As shown in FIG. 5E, the contents of the virtual machine management table 24 (server #1) do not change even if the virtual machine 21 (VM #3) is added to the server apparatus 20 (server #2). As shown in FIG. 5F, a record of the virtual machine 21 (VM #3) is added to the virtual machine management table 24 (server #2), since the virtual machine 21 (VM #3) is added to the server apparatus 20 (server #2). As shown in FIG. 5G, a record showing that the RLU 361 (RLU #3) is an element configuring the VLU 360 #1 is added to the VLU/RLU/virtual machine management table 354.

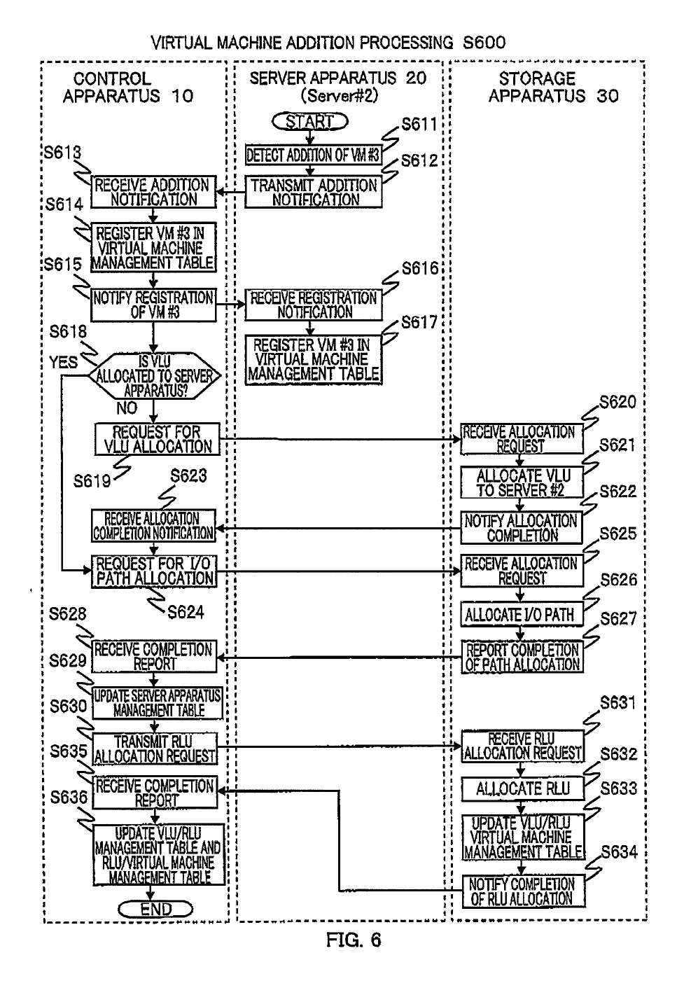

FIG. 6 is a flowchart illustrating processing (hereinafter called “virtual machine addition processing S600”) performed by the control apparatus 10 (the device manager 11), the server apparatus 20 (server #2) (the virtualization control unit 22 (#2)), and the storage apparatus 30 (the configuration management unit 351) when the virtual machine 21 (VM #3) is added to the server apparatus 20 (server #2).

When detecting the addition of the virtual machine 21 (VM #3) (S611), the server apparatus 20 (server #2) notifies the control apparatus 10 that the virtual machine 21 (VM #3) has been added (S612). Note that methods of detecting a configuration change (addition, deletion, or migration) of the virtual machine 21 by the control apparatus 10 include a method of acquiring the 3S changed content from the control apparatus 10, a method of performing polling whenever necessary to the server apparatus 20 from the control apparatus 10, and the like.

Upon receipt of the notification that the virtual machine 21 (VM #3) has been added (S613), the control apparatus 10 adds a record (see FIG. 5B) relating to the virtual machine 21 (VM #3) to the virtual machine/server apparatus management table 14 (S614), and notifies the server apparatus 20 (server #2) that the virtual machine/server apparatus management table 14 has been updated (S615). Upon receipt of the notification (S616), the server apparatus 20 (server #2) adds a record (see FIG. 5F) of the virtual machine 21 (VM #3) to the virtual machine management table 24 (server #2) (S617). Note that the update of the virtual machine/server apparatus management table 14 by the server apparatus 20 may be performed by a method of actively requesting information such as the virtual machine ID from the server apparatus 20 to the control apparatus 10.

Next, the control apparatus 10 refers to the server apparatus management table 13, and then determines whether or not a VLU 360 accessible by the server apparatus 20 to which the virtual machine 21 has been added is currently allocated to the server apparatus 20 (S618). If the VLU 360 is allocated (S618: YES), the processing proceeds to S626. If the VLU 360 is not allocated (S618: NO), the processing proceeds to S619.

In S619, the control apparatus 10 transmits an allocation request of the VLU 360 to the storage apparatus 30. Upon receipt of the allocation request of the VLU 360 (S620), the storage apparatus 30 allocates the VLU 360 to the server apparatus 20 (server #2) (S621). At this time, if no VLU 360 exists yet, the storage apparatus 30 generates the VLU 360 and allocates the generated VLU 360 to the server apparatus 20 (server #2). Note that, as described above, the storage apparatus 30 allocates the VLU 360 to the virtual machine 21 so that the same VLU 360 (although not necessarily the same) is allocated to each of the virtual machines 21 implemented in the same server apparatus 20. A generation instruction of the VLU 360 may be transmitted from the server apparatus 20 (server #2) to the storage apparatus 30.

After allocating the VLU 360, the storage apparatus 30 notifies the control apparatus 10 of the allocation (S622). The control apparatus 10 receives the notification (S623).

In S624, the control apparatus 10 requests an allocation of an I/O path for accessing the VLU 360 (VLU #1) from the virtual machine 21 (VM #3) (S624). Note that the allocation of the I/O path refers to an allocation of a physical or logical communication resource (e.g., a communication port) for accessing the VLU 360 (VLU #1) from the virtual machine 21 (VM #3).

Upon receipt of the allocation request of the I/O path (S625), the storage apparatus 30 performs the allocation of the I/O path (S626), and notifies the control apparatus 10 of the allocation (S627). Upon receipt of the notification (S628), the control apparatus 10 adds a record (see FIG. 5A) in which the server apparatus 20 (server #2) and the VLU 360 (VLU #1) are associated with each other to the server apparatus management table 13 (S629).

Next, the control apparatus 10 transmits to the storage apparatus 30 an allocation request for allocation of the RLU 361 to the VLU 360 (VLU #1) (S630). Upon receipt of the request (S631), the storage apparatus 30 allocates the RLU 361 (e.g., the RLU 361 (#3)) to the VLU 360 (VLU #1) (S632). Note that, as described above, the storage apparatus 30 allocates the RLU 361 to the VLU 360 so that the RLU 361 configuring the VLU 360 allocated to each virtual machine 21 differs depending on the virtual machine 21. After the allocation of the RLU 361, the storage apparatus 30 updates the VLU/RLU/virtual machine management table 354 (S633) and then transmits an RLU allocation completion report to the control apparatus 10 (S634).

Upon receipt of the notification (S635), the control apparatus 10 updates the contents of the VLU/RLU management table 15 and the RLU/virtual machine management table 16 (S636).

With the above processing, when the virtual machine 21 is added to the server apparatus 20, the VLU 360 is automatically allocated to the virtual machine 21 added by the control apparatus 10, the server apparatus 20, and the storage apparatus 30. The allocation of the RLU 361 to the VLU 360 and configuration of the I/O path used so that the added virtual machine 21 can access the VLU 360 are also automatically performed. The same VLU 360 (VLU #1 in FIG. 5G) is allocated to the virtual machines 21 in the same server apparatus 20, and different RLUs 361 are allocated to the respective virtual machines 21. Therefore, even if the virtual machine 21 is added, the user does not need to manually perform partitioning of the storage area, configuration of the I/O path for the virtual machine 21 to access the VLU 360, and the allocation of the RLU 361 to the VLU 360. Thus, there is basically no work load on the user in adding the virtual machine 21.

### <Processing in Deleting a Virtual Machine>

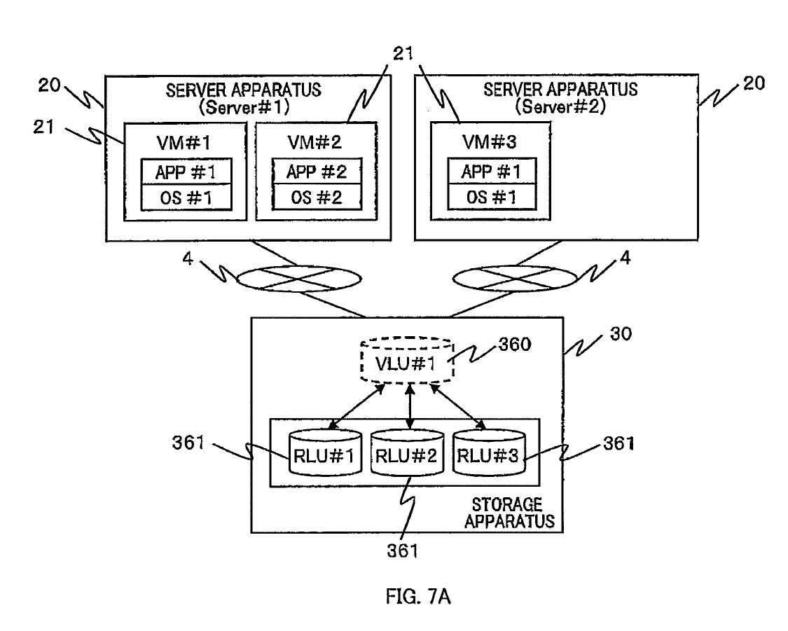

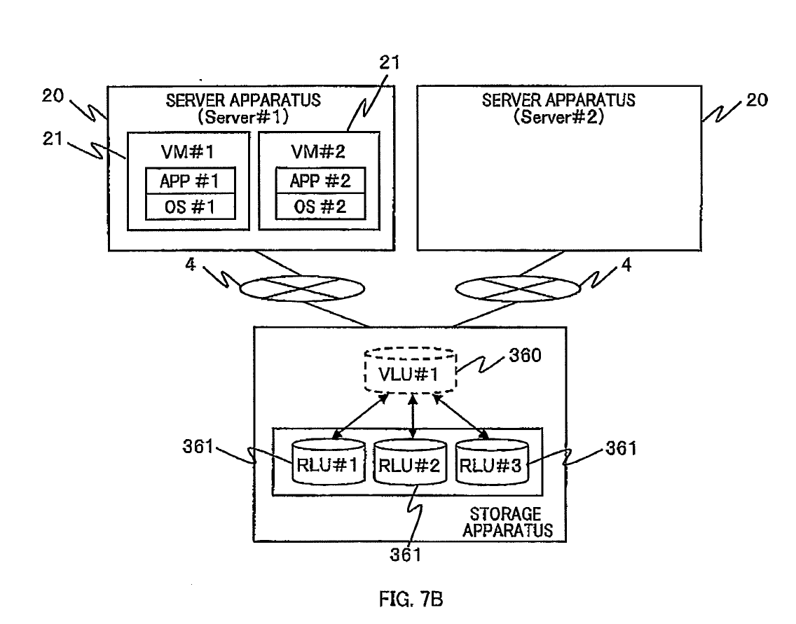

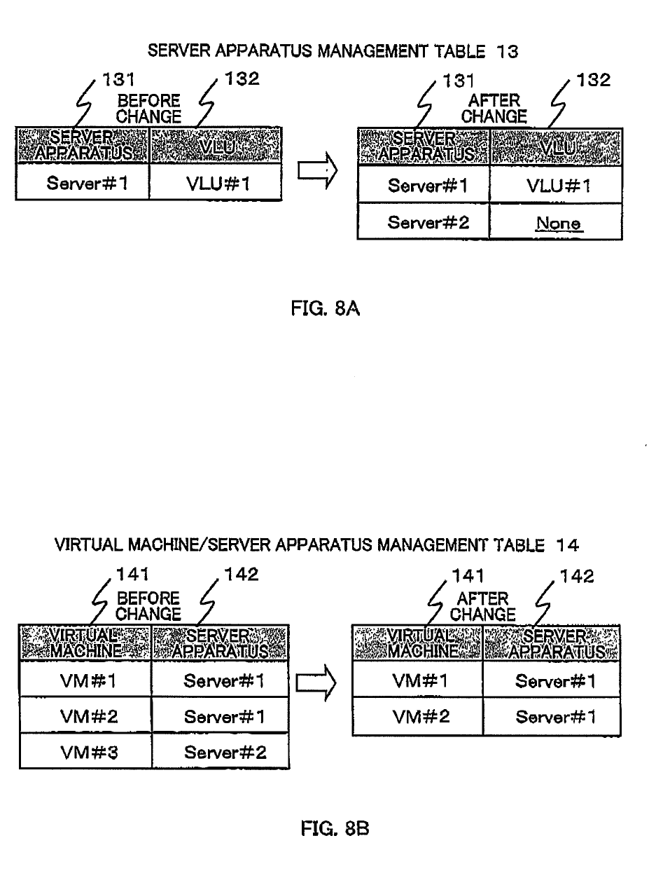

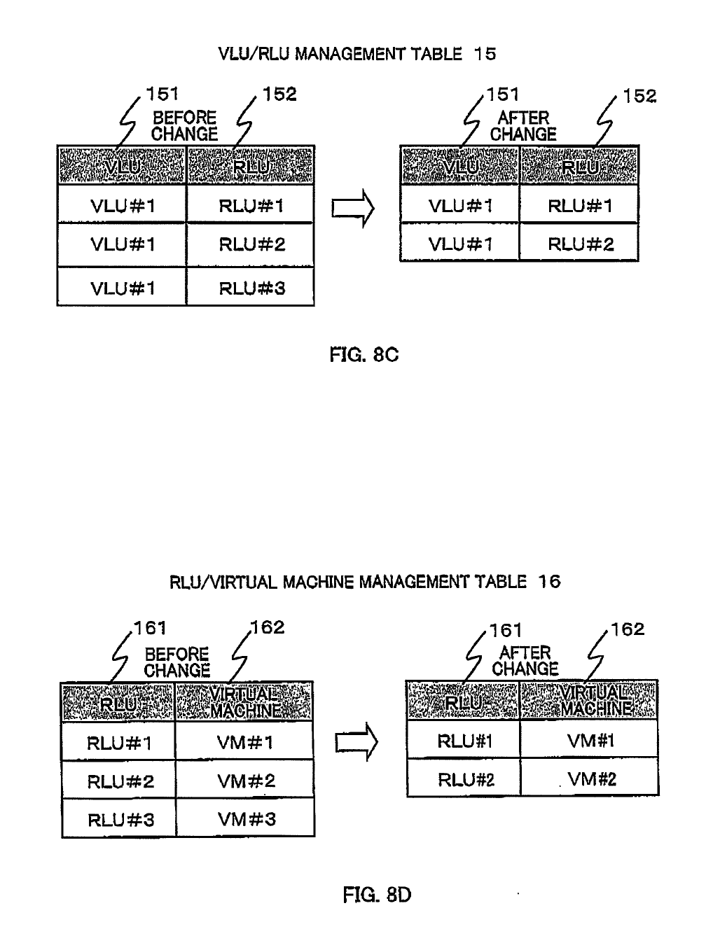

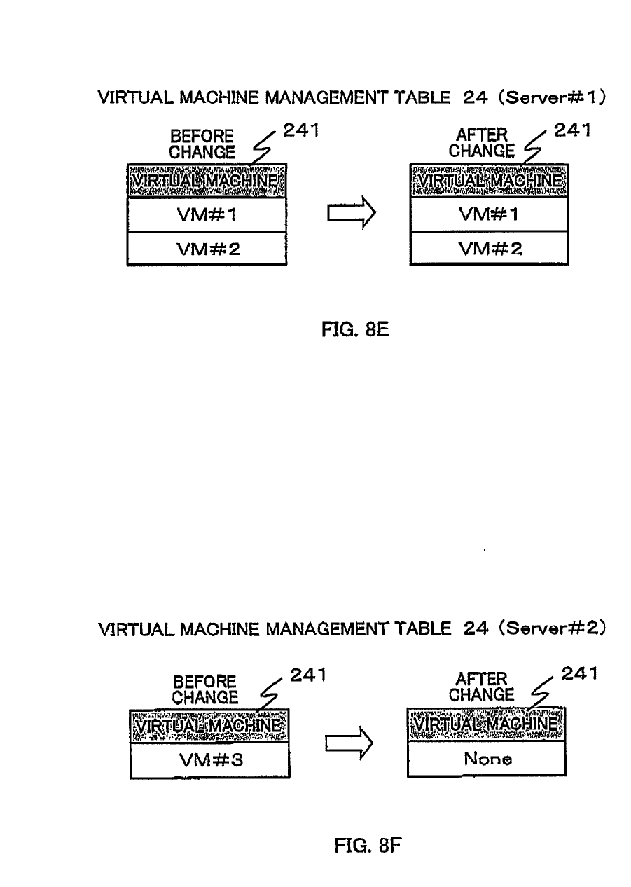

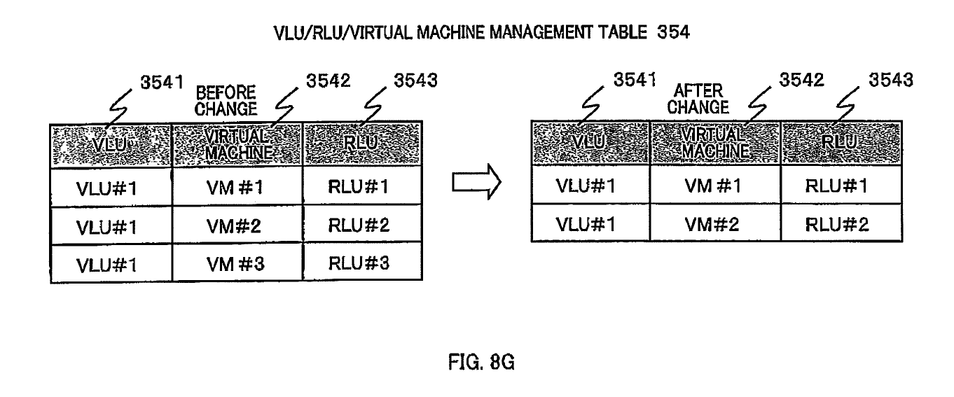

Next, as a second case, processing performed when the virtual machine 21 is deleted from the server apparatus 20 will be described. FIGS. 7A and 7B are views illustrating the deletion of the virtual machine 21 (VM #3) from the server apparatus 20 (server #2). FIG. 7A is a view showing a status before the virtual machine 21 (VM #3) is deleted, and FIG. 7B is a view showing a status after the virtual machine 21 (VM #3) has been deleted. FIGS. 8A to 8G are views showing changes of the tables at the time of configuration change from the status of FIG. 7A to the status of FIG. 7B.

As shown in FIG. 8A, when the virtual machine 21 (VM #3) is deleted from the server apparatus 20 (server #2), the record showing that the server apparatus 20 (server #2) and the VLU #1 correspond to each other is accordingly deleted from the server apparatus management table 13. As shown in FIG. 8B, the record showing that the virtual machine 21 (VM #3) and the server apparatus 20 (server #2) correspond to each other is deleted from the virtual machine/server apparatus management table 14. As shown in FIG. 8C, the record showing that the RLU 361 (RLU #3) is an element configuring the VLU 360 (VLU #1) is deleted from the VLU/RLU management table 15. Further, as shown in FIG. 8D, the record showing that the RLU 361 (RLU #3) is associated with the virtual machine 21 (VM #3) is deleted from the RLU/virtual machine management table 16.

As shown in FIG. 8E, the contents of the virtual machine management table 24 (server #1) do not change even if the virtual machine 21 (VM #3) is deleted from the server apparatus 20 (server #2). As shown in FIG. 8F, the record of the virtual machine 21 (VM #3) is deleted from the virtual machine management table 24 (server #2) since the virtual machine 21 (VM #3) is deleted from the server apparatus 20 (server #2). As shown in FIG. 8G, the record in which the virtual machine 21 (VM #3), the VLU 360 (VLU #1), and the RLU 361 (RLU #3) are associated with each other is deleted from the VLU/RLU/virtual machine management table 354.

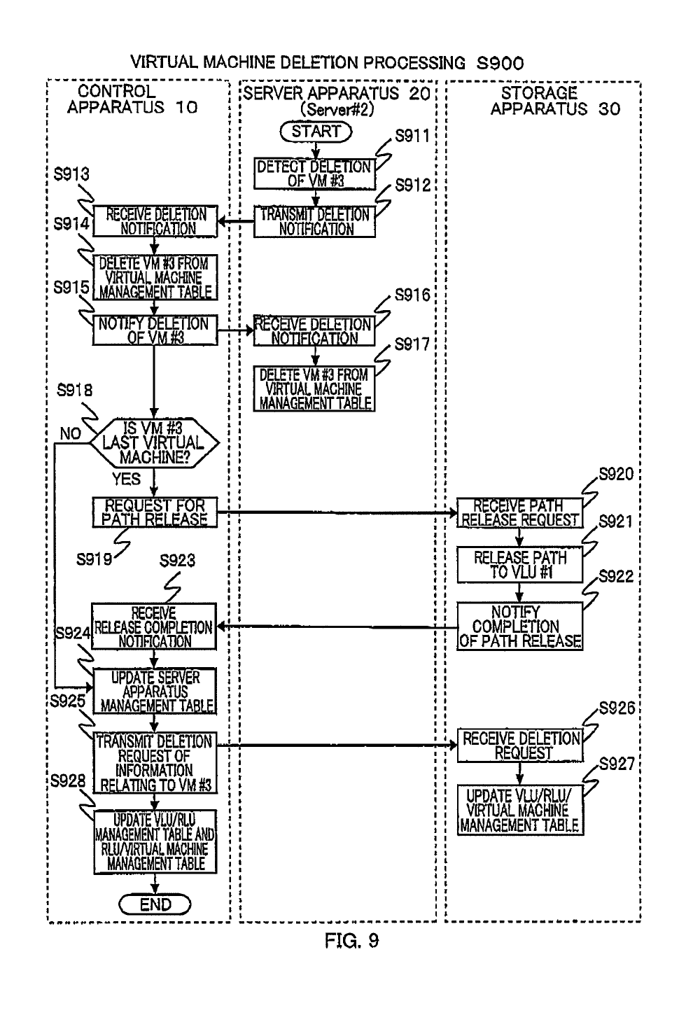

FIG. 9 is a flowchart illustrating processing (hereinafter called “virtual machine deletion processing S900”) performed by the control apparatus 10 (the device manager 11), the server apparatus 20 (server #2) (the virtualization control unit 22 (#2)) and the storage apparatus 30 (the configuration management unit 351) when the tables shown in FIGS. 8A to 8G are updated.

First, when the server apparatus 20 (server #2) detects that the virtual machine 21 (VM #3) is deleted (S911), the server apparatus 20 (server #2) notifies the control apparatus 10 that the virtual machine 21 (VM #3) has been deleted (S912).

Upon receipt of the notification that the virtual machine 21 (VM #3) has been deleted (S913), the control apparatus 10 deletes the record (see FIG. 8B) relating to the virtual machine 21 (VM #3) from the virtual machine/server apparatus management table 14 (S914), and then notifies the server apparatus 20 (server #2) that the virtual machine/server apparatus management table 14 has been updated (S915). Upon receipt of the notification (S916), the server apparatus 20 (server #2) deletes the record (see FIG. 8F) of the virtual machine 21 (VM #3) from the virtual machine management table 24 (server #2) (S917).

In S915, the control apparatus 10 determines whether or not the virtual machine 21 (VM #3) no longer exists in the server apparatus 20 (server #2) due to the deletion of the virtual machine 21 (VM #3), i.e., whether or not the deleted virtual machine 21 (VM #3) has been the last virtual machine 21 in the server apparatus 20 (server #2). If the virtual machine 21 (VM #3) no longer exists (S918: YES), the processing proceeds to S919. If another virtual machine 21 remains in the server apparatus 20 (server #2) (S918: NO), the processing proceeds to S919.

In S919, the control apparatus 10 transmits to the storage apparatus 30 an allocation release request of the I/O path for the access from the server apparatus 20 (server #2) to the VLU 360 (VLU #1). Upon receipt of the I/O path allocation release request (S920), the storage apparatus 30 releases the allocation of the I/O path for the access from the server apparatus 20 (server #2) to the VLU 360 (VLU #1) (S921). After the release of the allocation of the I/O path, the storage apparatus 30 transmits a path release completion notification to the control apparatus 10 (S922). The control apparatus 10 receives the path release completion notification (S923).

In S924, the control apparatus 10 deletes the record (see FIG. 8A) in which the server apparatus 20 (server #2) and the VLU 360 (VLU #1) are associated with each other from the server apparatus management table 13 (S924).

In S925, the server apparatus 20 (server #2) transmits a delete request for information relating to the virtual machine 21 (VM #3) to the storage apparatus 30. Upon receipt of the delete request (S926), the storage apparatus 30 deletes the information (see FIG. 8G) relating to the virtual machine 21 (VM #3) from the VLU/RLU/virtual machine management table 354 (S927). At this time, the server apparatus 20 (server #2) updates the contents of the VLU/RLU management table 15 and the RLU/virtual machine management table 16.

Note that, in order to ensure security, the storage apparatus 30 performs shredding processing or the like as appropriate on data stored in the RLU 361 (#3) (in an unused status) whose allocation to the VLU 360 is released.

With the above processing, when the virtual machine 21 is deleted from the server apparatus 20, the information relating to the deleted virtual machine 21 is automatically deleted. The release of the allocation of the RLU 361 to the VLU 360 and a release of the configuration of the I/O path used for the deleted virtual machine 21 to access the VLU 360 are also automatically performed. The status where the same VLU 360 (VLU #1 in FIG. 8G) is allocated to the virtual machines 21 in the same server apparatus 20 and the status where different RLUs 361 are allocated to the respective virtual machines 21 are maintained. Therefore, even if the virtual machine 21 is deleted, the user does not need to manually perform partitioning of the storage area, configuration of the I/O path for the virtual machine 21 to access the VLU 360, and the allocation of the RLU 361 to the VLU 360. Thus, there is basically no work load on the user in deleting the virtual machine 21.

### <Processing in Migrating a Virtual Machine>

Next, as a third case, processing performed when the virtual machine 21 is migrated between the server apparatuses 20 by using a migration function of the virtual machine 21 of the virtualization control units 22 (#1 and #2) will be described.

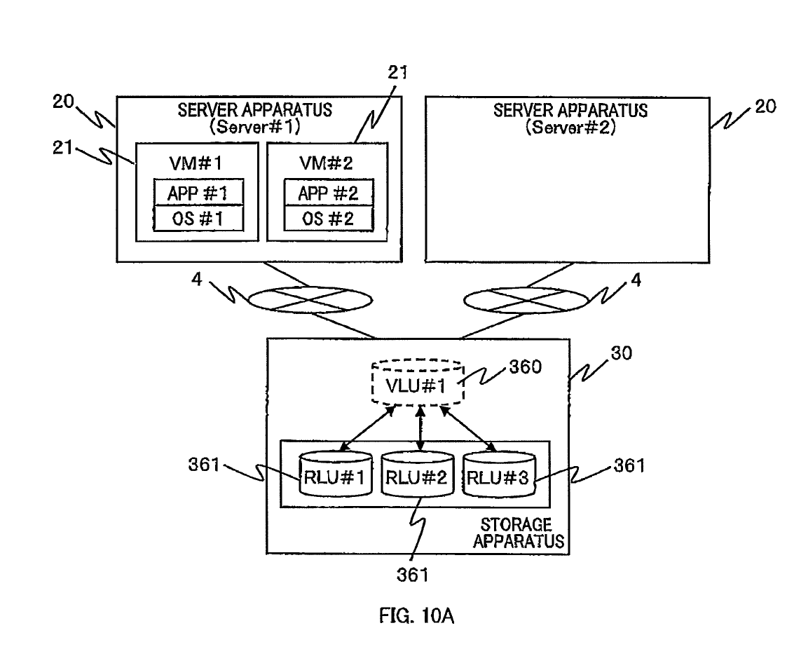

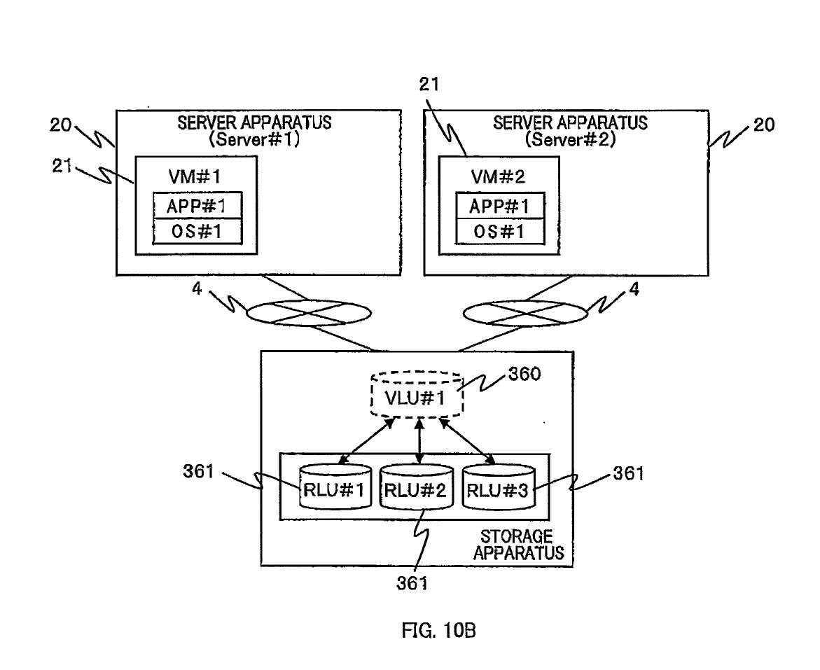

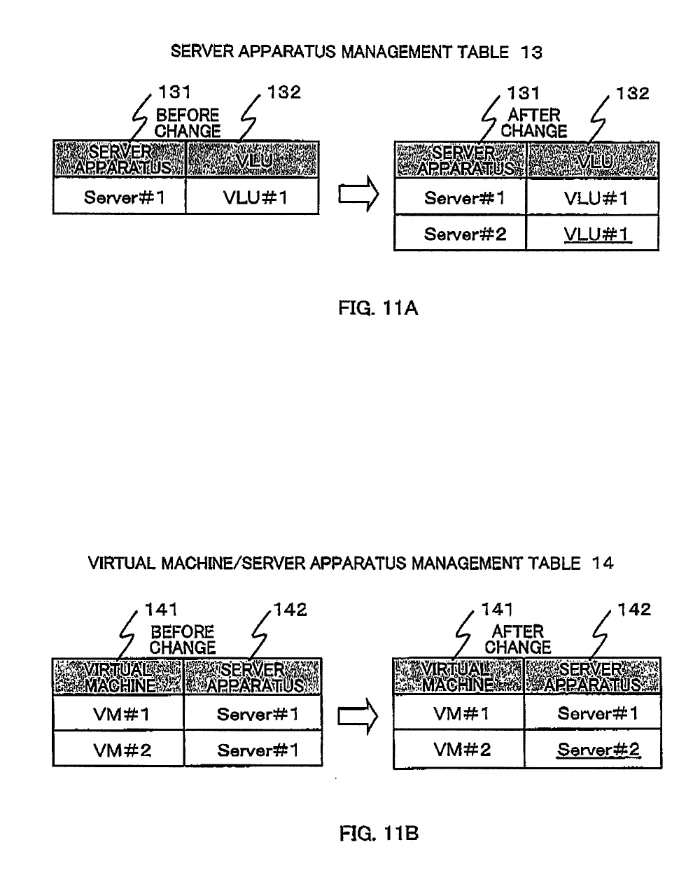

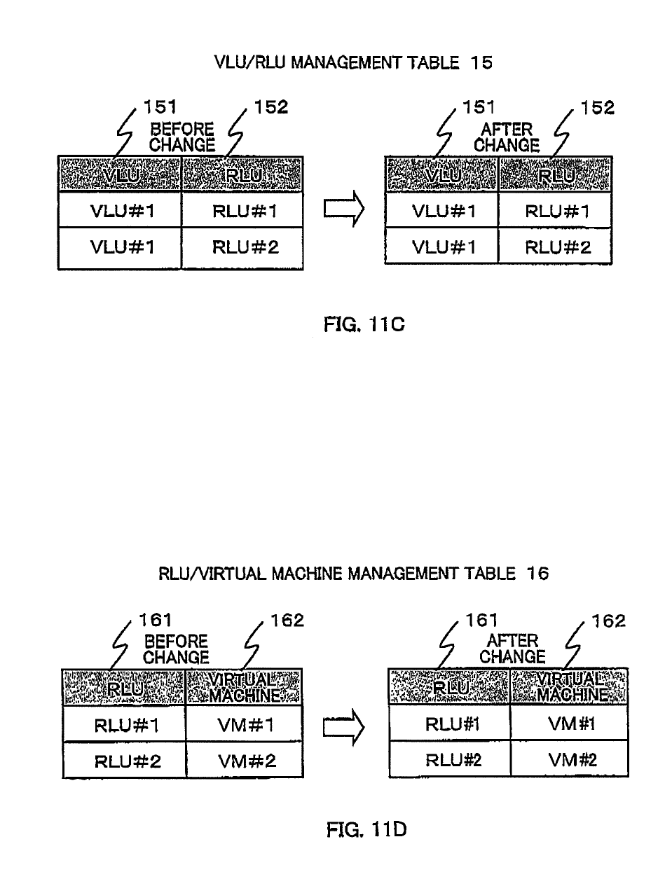

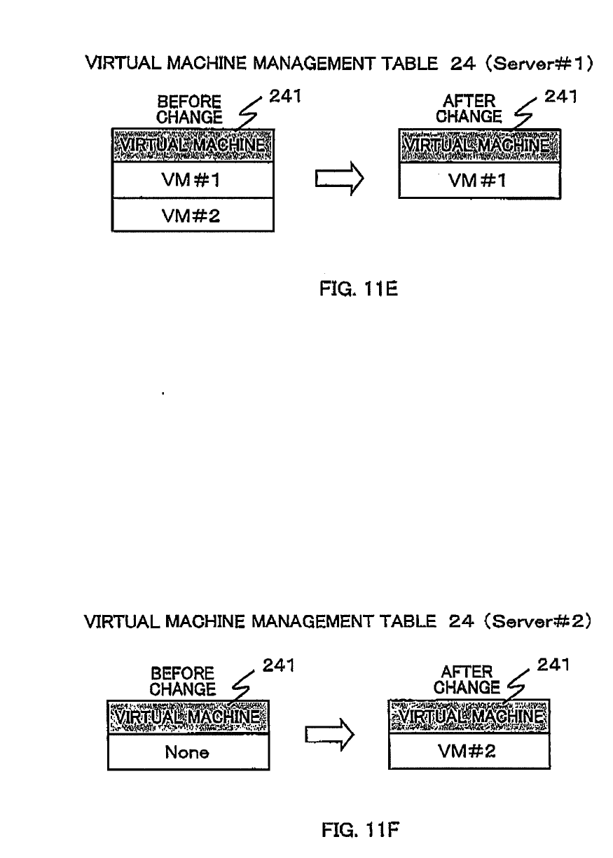

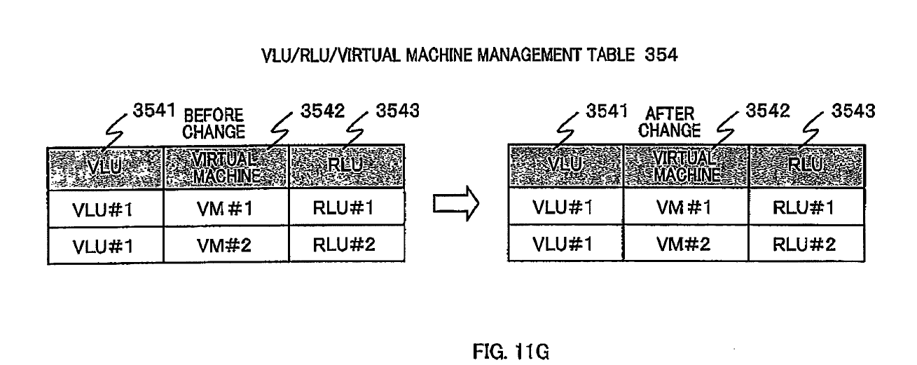

FIGS. 10A and 10B are views illustrating the migration of the virtual machine 21 (VM #2) that was in the server apparatus 20 (server #1) to the server apparatus 20 (server #2). FIG. 10A shows a status before the migration of the virtual machine 21 (VM #2), and FIG. 10B shows a status after the migration of the virtual machine 21 (VM #2). FIGS. 11A to 11G are views showing changes in the respective tables at the time of the migration.

As shown in FIG. 11A, as the migration of the virtual machine 21 (VM #2) is migrated, a record showing that the server apparatus 20 (server #2) and the VLU #1 correspond to each other is added to the server apparatus management table 13. As shown in FIG. 11B, the record showing that the virtual machine 21 (VM #2) and the server apparatus 20 (server #1) correspond to each other is deleted from the virtual machine/server apparatus management table 14, and instead a record showing that the virtual machine 21 (VM #2) and the server apparatus 20 (server #2) correspond to each other is added. As shown in FIG. 11C, the relation between the VLU 360 and the RLU 361 does not change even if the virtual machine 21 (VM #2) is migrated to the server apparatus 20 (server #2). As shown in FIG. 11D, the relation between the virtual machine 21 and the RLU 361 does not change even if the virtual machine 21 (VM #2) is migrated to the server apparatus 20 (server #2).

As shown in FIG. 11E, the record of the virtual machine 21 (VM #2) is deleted from the virtual machine management table 24 (server #1) since the virtual machine 21 (VM #2) is migrated to the server apparatus 20 (server #2). As shown in FIG. 11F, the contents of the virtual machine management table 24 (server #2) are updated so that a record of the virtual machine 21 (VM #2) is added, since the virtual machine 21 (VM #2) is migrated to the server apparatus 20 (server #2). As shown in FIG. 11G, even if the virtual machine 21 (VM #2) is migrated to the server apparatus 20 (server #2), the relation among the VLU 360, the virtual machine 21, and the RLU 361 does not change, so that the contents of the VLU/RLU/virtual machine management table 354 does not change.

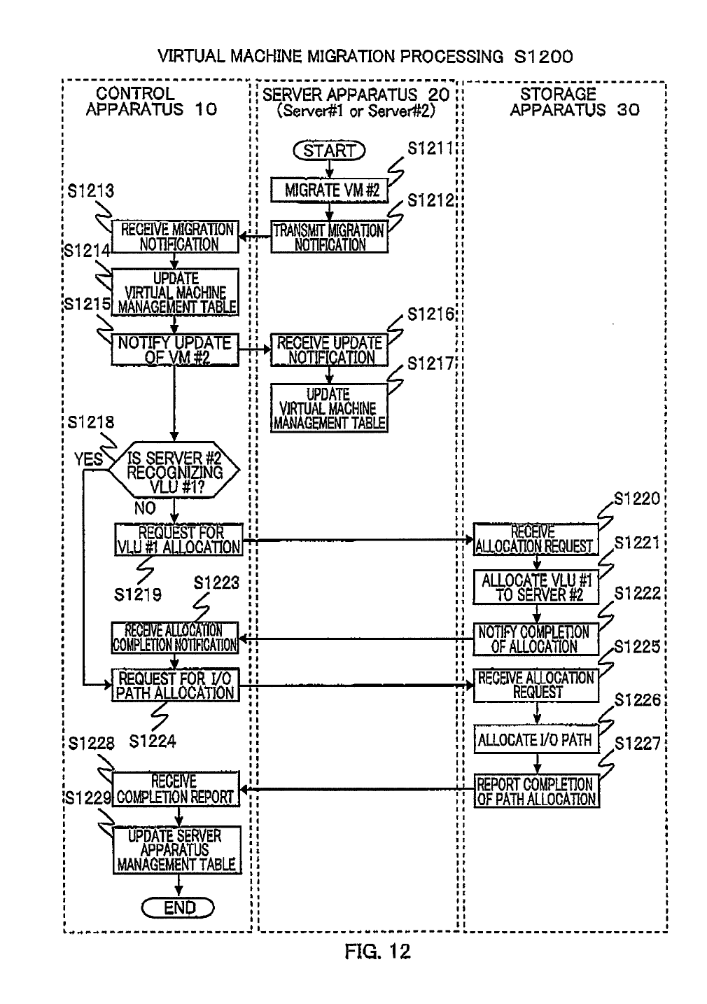

FIG. 12 is a flowchart illustrating processing (hereinafter called “virtual machine migration processing S1200”) performed by the control apparatus 10 (the device manager 11), the server apparatuses 20 (servers #1 and #2) (the virtualization control units 22 (#1 and #2)), and the storage apparatus 30 (the configuration management unit 351) when the tables shown in FIGS. 11A to 11G are updated.

First, when the virtual machine 21 (VM #2) is migrated (S1211), the server apparatuses 20 (servers #1 and #2) notifies the control apparatus 10 of an occurrence of the migration (S1212).

Upon receipt of the notification that the virtual machine 21 (VM #2) is migrated (S1213), the control apparatus 10 updates the virtual machine/server apparatus management table 14 (see FIG. 11B) (S1214), and notifies the server apparatuses 20 (servers #1 and #2) that the virtual machine/server apparatus management table 14 has been updated (S1215). Upon receipt of the notification (S1216), the server apparatuses 20 (servers #1 and #2) update the virtual machine management tables 24 (servers #1 and #2) (see FIGS. 11E and 11F) (S1217).

Next, the control apparatus 10 refers to the server apparatus management table 13, and then determines whether or not the server apparatus 20 (server #2) has already recognized the VLU 360 (VLU #1) which has been recognized by the server apparatus 20 (server #1) (S1218). If the VLU 360 (VLU #1) is already recognized (S1218: YES), the processing proceeds to S1226. If the server apparatus 20 (server #2) has not yet recognized the VLU 360 (VLU #1) (S1218: NO), the processing proceeds to S1219.

In S1219, the control apparatus 10 transmits to the storage apparatus 30 an allocation request for allocation of the VLU 360 (VLU #1) to the server apparatus 20 (server #2). Upon receipt of the allocation request (S1220), the storage apparatus 30 allocates the VLU 360 to the server apparatus 20 (server #2) (S1221). After allocating the VLU 360 (VLU #1) to the server apparatus 20 (server #2), the storage apparatus 30 transmits a VLU allocation completion notification to the control apparatus 10 (S1222).

In S1224, the control apparatus 10 requests an allocation of an I/O path for access from the virtual machine 21 (VM #2) to the VLU 360 (VLU #1) (S1224). Upon receipt of the I/O path allocation request (S1225), the storage apparatus 30 performs the allocation of the I/O path for the access from the virtual machine 21 (VM #2) to the VLU 360 (VLU #1) (S1226), and then transmits an allocation completion notification of the I/O path to the control apparatus 10 (S1227). Upon receipt of the allocation completion notification (S1228), the control apparatus 10 adds a record (see FIG. 11A) in which the server apparatus 20 (server #2) and the VLU 360 (VLU #1) are associated with each other, to the server apparatus management table 13 (S1229).

With the above processing, in the migration of the virtual machine 21 performed between server apparatuses 20, the VLU 360 is automatically allocated to the virtual machine 21. The configuration of the I/O path used for the virtual machine 21 in the server apparatus 20 as a migration destination to access the VLU 360 is also automatically performed. The status where the same VLU 360 (VLU #1 in FIG. 11G) is allocated to the virtual machines 21 in the same server apparatus 20 and the status where different RLUs 361 are allocated to the respective virtual machines 21 are maintained. Therefore, even if the virtual machine 21 is migrated, the user does not need to manually perform partitioning of the storage area, configuration of the I/O path for the virtual machine 21 to access the VLU 360, and the allocation of the RLU 361 to the VLU 360. Thus, there is basically no work load on the user in migrating the virtual machine 21.

### =Processing at Occurrence of I/O Request=

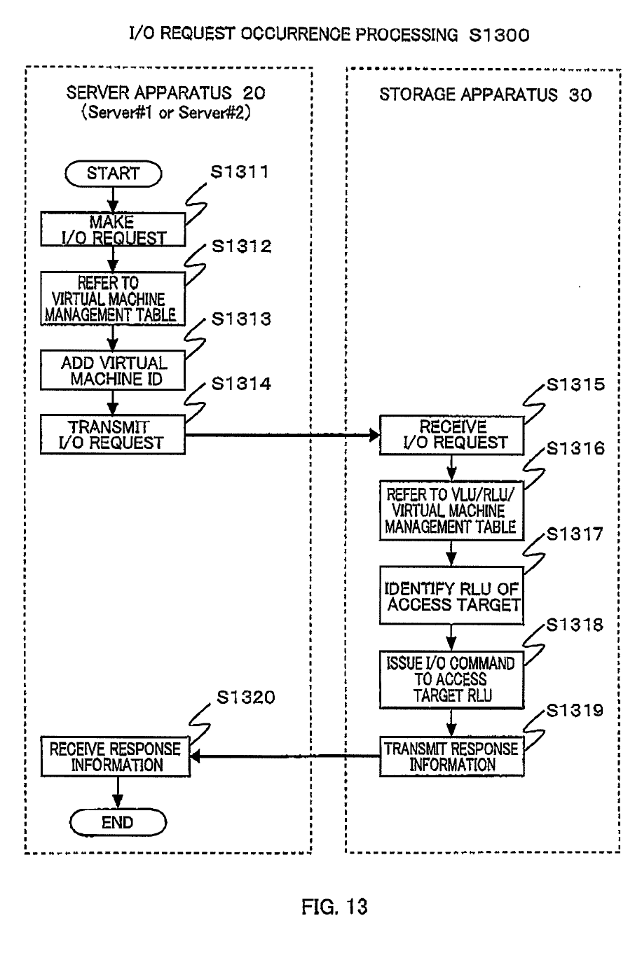

Next, processing relating to an I/O request from the virtual machine 21 to the VLU 360 will be described. Note that the I/O request occurs, for example, when the server apparatus 20 has received a data access request from the client apparatus 60. FIG. 13 is a flowchart illustrating the processing (hereinafter called “I/O request occurrence processing S1300”). Hereinafter, the I/O request occurrence processing S1300 will be described with reference to FIG. 13.

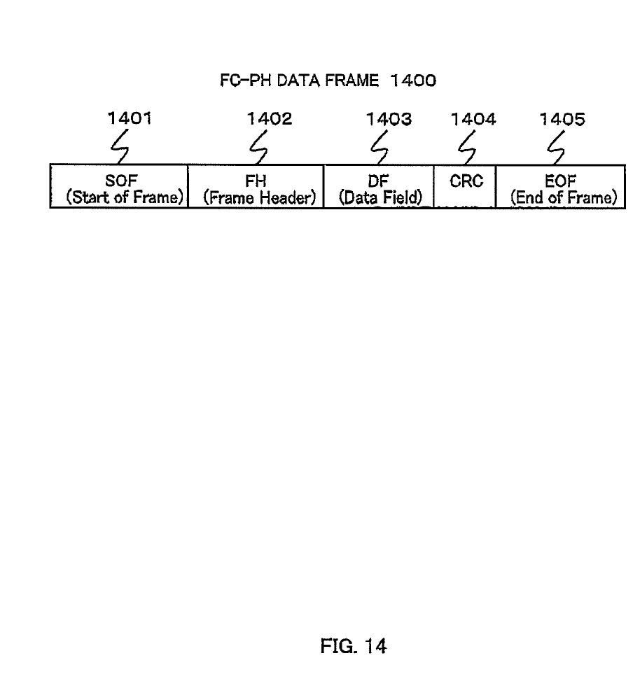

When the I/O request is made from the virtual machine 21 to the VLU 360 (S1311), the server apparatus 20 acquires the virtual machine ID of the virtual machine 21 as an I/O request source from the virtual machine management table 24 (S1312), and then transmits the I/O request with the acquired virtual machine ID, to the storage apparatus 30 (S1313 and S1314). For example, when the communication between the server apparatus 20 and the storage apparatus 30 is performed in accordance with a fibre channel physical and signaling interface (FC-PH), the virtual machine ID is stored in a frame header (FH) of an FC-PH data frame 1400 shown in FIG. 14.

Upon receipt of the I/O request (S1315), the storage apparatus 30 refers to the VLU/RLU/virtual machine management table 354 (S1316) and then identifies the RLU 361 to be accessed, from the virtual machine ID added to the I/O request (S1317).

In S1318, the storage apparatus 30 issues an I/O command to the RLU 361 identified in S1317. Then, the storage apparatus 30 transmits response information (processing result of a data write command, or data read by a data read command) acquired according to the I/O command to the server apparatus 20 (S1319). Upon receipt of the response information (S1320), the server apparatus 20 transmits a response to the client apparatus 60, for example. When the I/O request is made in the server apparatus 20, the processing described above is performed.

Note that, as described above in the information system 1 of the present embodiment, the same VLU 360 is allocated to the virtual machines 21 in the same server apparatus 20, and different RLUs 361 are allocated to the respective virtual machines 21. Therefore, as described above, the storage apparatus 30 can easily and reliably identify the RLU 361 of an access target from the virtual machine ID added to the FC-PH data frame 1400.

The description of the embodiment above is to facilitate an understanding of the present invention, and is not intended to limit the present invention. It is needless to say that the present invention may be changed or modified without departing from the gist thereof and that the present invention also includes equivalents thereof.

What is claimed is:

1. An information system comprising:
a server apparatus; and
a storage apparatus coupled to the server apparatus, wherein
the server apparatus includes a virtualization control unit which implements a virtual machine,
the storage apparatus includes a virtual logical volume management unit which provides the server apparatus with a virtual logical volume configured by using a real logical volume,
the storage apparatus allocates the virtual logical volume to each of the virtual machines implemented in the same server apparatus and configures the real logical volume configuring the virtual logical volume so that the real logical volumes configuring the virtual logical volumes allocated to the virtual machines respectively are different from each other depending on the virtual machine,
the server apparatus transmits to the storage apparatus an I/O request with an identifier of the virtual machine added when the I/O request is made by the virtual machine, and
the storage apparatus identifies the real logical volume of an access target in the I/O request on the basis of the identifier of the virtual machine, which is added to the I/O request.

2. The information system according to claim 1, further comprising:
a control apparatus coupled to the server apparatus and the storage apparatus, wherein
the control apparatus stores:
a server apparatus management table storing a correspondence between the server apparatus and the virtual logical volume allocated to the server apparatus;
a virtual machine/server apparatus management table storing a correspondence between the virtual machine and the server apparatus;
a virtual logical volume/real logical volume management table storing a correspondence between the virtual logical volume and the real logical volume; and
a real logical volume/virtual machine management table storing a correspondence between the real logical volume and the virtual machine, wherein
the server apparatus stores a virtual machine management table storing an identifier of the virtual machine implemented in the server apparatus itself,
the storage apparatus stores a virtual logical volume/real logical volume/virtual machine management table storing a correspondence among the virtual logical volume, the virtual machine, and the real logical volume, and,
when a configuration change is made on the virtual machine implemented in the server apparatus, at least one of the control apparatus, the server apparatus, and the storage apparatus updates contents of the server apparatus management table, the virtual machine/server apparatus management table, the virtual logical volume/real logical volume management table, the real logical volume/virtual machine management table, the virtual machine management table, and the virtual logical volume/real logical volume/virtual machine management table, to the contents in a status after the configuration change.

3. The information system according to claim 2, wherein the configuration change is any one of an addition of the virtual machine to the server apparatus, a deletion of the virtual machine from the server apparatus, and a migration of the virtual machine from a first server apparatus to a second server apparatus.

4. The information system according to claim 3, wherein
the configuration change is the addition of the virtual machine to the server apparatus,
when the virtual logical volume is not allocated to the server apparatus to which the virtual machine is added, the control apparatus transmits, to the storage apparatus, an allocation request for allocating the virtual logical volume to the server apparatus, and
the storage apparatus allocates the virtual logical volume and an I/O path from the virtual machine to the virtual logical volume, to the server apparatus in response to the allocation request.

5. The information system according to claim 3, wherein
the configuration change is the deletion of the virtual machine from the server apparatus or the migration of the virtual machine from the first server apparatus to the second server apparatus,
when the virtual machine no longer exists in the server apparatus due to the deletion of the virtual machine, the control apparatus transmits, to the storage apparatus, an allocation release request of the I/O path from the virtual machine to the virtual logical volume, and
the storage apparatus releases the allocation of the I/O path in response to the allocation release request.

6. A method of controlling information for an information system which comprises a server apparatus and a storage apparatus coupled to the server apparatus, in which the server apparatus includes a virtualization control unit implementing a virtual machine, and in which the storage apparatus includes a virtual logical volume management unit providing the server apparatus with a virtual logical volume configured by using a real logical volume,
the method comprising the steps of:
allocating the virtual logical volume to each of the virtual machines implemented in the same server apparatus and configuring the real logical volume configuring the virtual logical volume so that the real logical volumes configuring the virtual logical volumes allocated to the virtual machines respectively are different from each other depending on the virtual machine, by the storage apparatus;
transmitting to the storage apparatus, an I/O request with an identifier of the virtual machine added, by the server apparatus, when the I/O request is made in the virtual machine; and
identifying the real logical volume of an access target in the I/O request on the basis of the identifier of the virtual machine, which is added to the I/O request, by the storage apparatus.

7. The method of controlling information according to claim 6, wherein a control apparatus coupled to the server apparatus and the storage apparatus is further provided,
the method comprising the steps of:
storing a server apparatus management table wherein a correspondence between the server apparatus and the virtual logical volume allocated to the server apparatus is stored,
a virtual machine/server apparatus management table wherein a correspondence between the virtual machine and the server apparatus is stored,
a virtual logical volume/real logical volume management table wherein a correspondence between the virtual logical volume and the real logical volume is stored, and
a real logical volume/virtual machine management table wherein a correspondence between the real logical volume and the virtual machine is stored, in the control apparatus;
storing a virtual machine management table wherein an identifier of the virtual machine implemented in the server apparatus is stored, in the server apparatus;
storing a virtual logical volume/real logical volume/virtual machine management table wherein a correspondence among the virtual logical volume, the virtual machine, and the real logical volume is stored, in the storage apparatus; and
when a configuration change is made on the virtual machine implemented in the server apparatus, updating contents of the server apparatus management table, the virtual machine/server apparatus management table, the virtual logical volume/real logical volume management table, the real logical volume/virtual machine management table, the virtual machine management table, and the virtual logical volume/real logical volume/virtual machine management table, to the contents in a status after the configuration change by at least one of the control apparatus, the server apparatus, and the storage apparatus.

8. The method of controlling information according to claim 7, wherein the configuration change is any one of an addition of the virtual machine to the server apparatus, a deletion of the virtual machine from the server apparatus, and a migration of the virtual machine from a first server apparatus to a second server apparatus.

9. The method of controlling information according to claim 8, wherein
the configuration change is the addition of the virtual machine to the server apparatus,
the method comprising the steps of:
transmitting to the storage apparatus an allocation request for allocating the virtual logical volume to the server apparatus, by the control apparatus, when the virtual logical volume is not allocated to the server apparatus to which the virtual machine is added,
allocating the virtual logical volume and an I/O path from the virtual machine to the virtual logical volume, to the server apparatus in response to the allocation request, by the storage apparatus.

10. The method of controlling information according to claim 8, wherein
the configuration change is the deletion of the virtual machine from the server apparatus or the migration of the virtual machine from the first server apparatus to the second server apparatus,
the method comprising the steps of:
transmitting, to the storage apparatus, an allocation release request of an I/O path from the virtual machine to the virtual logical volume, by the control apparatus, when the virtual machine no longer exists in the server apparatus due to the deletion of the virtual machine, and
releasing an allocation of the I/O path in response to the allocation release request by the storage apparatus.

11. The control apparatus used for the information system according to claim 2, wherein the control apparatus stores:
the server apparatus management table storing the correspondence between the server apparatus and the virtual logical volume allocated to the server apparatus;
the virtual machine/server apparatus management table storing the correspondence between the virtual machine and the server apparatus;
the virtual logical volume/real logical volume management table storing the correspondence between the virtual logical volume and the real logical volume; and
the real logical volume/virtual machine management table storing the correspondence between the real logical volume and the virtual machine.

12. The control apparatus used for the information system according to claim 4, wherein the control apparatus transmits, to the storage apparatus, the allocation request for allocating the virtual logical volume to the server apparatus when the virtual logical volume is not allocated to the server apparatus to which the virtual machine is added.

13. The control apparatus used for the information system according to claim 5, wherein the control apparatus transmits, to the storage apparatus, the allocation release request of the I/O path from the virtual machine to the virtual logical volume when the virtual machine no longer exists in the server apparatus due to the deletion of the virtual machine.
